(19) United States
(12) Patent Application Publication
(10) Pub. No.: US 2025/0341343 A1
(43) Pub. Date: Nov. 6, 2025

(54) MULTIPLE FLOW CHANNEL FULL CONTACT FIN HEAT EXCHANGE MECHANISM

(71) Applicant: Winconn Systems INC., Taipei City (TW)

(72) Inventor: Jun LIN, Taipei City (TW)

(21) Appl. No.: 18/772,271

(22) Filed: Jul. 15, 2024

(30) Foreign Application Priority Data
May 2, 2024 (TW) 113116685

(51) Int. Cl. F24S 10/25; F28F 1/12

(52) U.S. Cl. CPC F24S 10/25; F28F 1/12

(57) ABSTRACT

A multiple flow channel full contact fin heat exchange mechanism includes a heat concentration unit and a heat transfer assembly. The heat concentration unit is arranged at a focusing position of a soler energy reflection heat-concentration device. The heat transfer assembly is arranged on the heat concentration unit. Multiple groups of heat exchange flow channels are formed between the heat transfer assembly and the heat concentration unit. Two adjacent groups of heat exchange flow channels are connected in sequence. All of the heat exchange flow channels are arranged parallel in a linear direction. By having the multiple groups of heat exchange flow channels arranged between the heat transfer assembly and the heat concentration unit and two adjacent groups of heat exchange flow channels connected in sequence and arranged in parallel in a linear direction, fluid flowing in the heat exchange flow channels directly contacts the heat transfer assembly.

### BACKGROUND OF THE INVENTION

### (a) Technical Field of the Invention

The present invention relates to the technical field of heat exchange, and more particularly to a multiple flow channel full contact fin heat exchange mechanism.

### (b) Description of the Prior Art

A solar reflector is constituent part of a focusing solar energy collector and functions to have solar radiation concentrated on an absorber through reflection or refraction. Solar reflectors are classified in two types, the reflective type and the refractive (transmissive) type and have two operation modes, which are a fixed mode and a tracking mode. The reflective solar reflectors use high reflectivity materials to focus scattered sunlight on a receiver; and the refractive solar reflectors use convex lenses and Fresnel lenses to refract and focus sunlight on the receiver.

For example, Patent Application No. CN200810045649.X, of which the title is solar energy point focusing heat exchange device, teaches that a heat exchanger is fixedly connected to a device frame through a coupling; one end of an azimuth rotating axle is connected to an output axle of a bidirectional driver; the bidirectional driver is located on a mounting base; the mounting base is fixedly connected to the device frame; another end of the azimuth rotating axle is coupled with a bearing of a connecting piece arranged on an elevation rotating axle; the elevation rotating axle is coupled with a bearing arranged on the device base; an inner cavity of a housing of the heat exchanger is divided by a partition layer arranged therein into a heat collection chamber and a heat exchange chamber; a heat conduction pipe is arranged in the heat exchange chamber to penetrate through the partition layer into the heat collection chamber; the heat exchange chamber includes a working medium input pipe and a working medium output pipe; the heat collection chamber includes a transmission port; and a solar energy collector is located on a mounting plate of the azimuth rotating axle.” Such a structure is conducive to solving the problems that existing devices are complicated in structure, high is cost, and limited in working medium.

However, a heat exchange structure mounting site of such a structure is as follows. “A main body of the heat conduction pipe is provided with heat exchange fins located in the heat exchange chamber, one end of which penetrates through the partition layer to locate in the heat collection chamber and having a terminal portion including a heat collection head.” The heat exchange fin has a shape and a structure as follows. “The heat exchange fins can be in the form of a plate or in the form of a needle, and are preferably made in a three-dimensional curve or a configuration of a curved line, in order to expand a heat exchange area.” It can be learned, when observed made in combination with FIG. 4 of the Patent, that the heat exchange structure of the traditional solar reflective heat condensation device generally adopts a fin-like structure, and when the heat exchange medium flows into the heat exchange comber to exchange heat with the heat exchange fins, because gaps among some of the fins cannot be set in alignment with a medium conveying tube (in the Patent, an extension direction of the gaps among the fins being perpendicular to an output opening extension direction of the conveying tube), in a condition that the flow speed of the medium is relatively fast, the gaps among some of the fins do not get any medium to pass therethrough in the entire process of heat exchange, resulting in a significant deviation of the heat exchange efficiency from an idea condition. Further, the fins that are ineffective for heat exchange occupy a space, influencing the utilization of the device and disadvantageous to business development.

### SUMMARY OF THE INVENTION

An objective of the present invention is to provide a multiple flow channel full contact fin heat exchange mechanism, aiming to resolve the deficiency existing in a fin heat exchange structure of a prior art solar reflection and collection device, in which gaps among some fins is not effectively utilized, resulting in the heat exchange efficiency being lower than an idea value, causing technical problems with respect to waste of resources, lowering of product reputation, and being disadvantageous to business development.

To achieve the above objective, an embodiment of the present invention provides a multiple flow channel full contact fin heat exchange mechanism, which is applicable to a solar energy reflection light-concentration device, and comprises a heat concentration unit and a heat transfer assembly, the heat concentration unit being arranged at a focusing position of the solar energy reflection light-concentration device, the heat transfer assembly being arranged on the heat concentration unit, wherein multiple groups of heat exchange flow channels are formed between the heat transfer assembly and the heat concentration unit, and two adjacent groups of the heat exchange flow channels are connected in sequence, and all of the heat exchange flow channels are arranged as being parallel arranged in a linear direction.

Preferably, the heat transfer assembly comprises heat exchange fins, a sealing member, and a flow channel board, multiple sets of the heat exchange fins being uniformly distributed on the heat concentration unit, the sealing member being arranged on the heat concentration unit and enclosing all of the heat exchange fins, the flow channel board being arranged on the sealing member, all of the heat exchange fins being are arranged side by side in a linear direction at intervals, each group of the heat exchange flow channels being formed between two sets of the heat exchange fins that correspond to each other.

Preferably, two adjacent groups of heat exchange flow channels are connected and in communication with each other by means of one single set of curved flow channels. Preferably, the heat exchange fins are formed, in a penetrating manner in both two ends thereof in a linear direction, with multiple sets of flow guide holes, and the flow guide holes are connected and in communication with the heat exchange flow channels, and the flow guide holes and the heat exchange flow channels are perpendicular to each other.

Preferably, the sealing member is formed, in a penetrating manner in both two ends of inside thereof in a linear direction, with multiple sets of flow guide holes, and the flow guide holes are connected and in communication with the heat exchange flow channels, and the flow guide holes and the heat exchange flow channels are perpendicular to each other.

Preferably, the heat exchange flow channels are formed, in a penetrating manner in both two ends thereof in a linear direction, with multiple sets of flow guide holes, and each set of flow guide holes accommodates at least two groups of heat exchange flow channels, and each set of flow guide holes is arranged, in a staggered manner, at two ends of the heat exchange flow channels in a linear direction.

Preferably, the sealing member is of a frame configuration arranged at an outside of the heat concentration unit, and the sealing member is in tight contact engagement with the heat concentration unit.

Preferably, the sealing member is formed, in a penetrating manner, with a water inlet hole and the water outlet hole, and fluid flows from the water inlet hole to sequentially pass through multiple groups of the heat exchange flow channels, to then flow out of the water outlet hole.

Preferably, the heat concentration unit comprises a heat concentration board and heat-increasing helical rings, the heat concentration board being arranged on the heat concentration unit, multiple sets of heat-increasing helical rings being arranged at a center of the heat concentration board, the heat-increasing helical rings being provided for expanding a light absorption area, the heat-increasing helical rings being of a helical structure.

Preferably, the sealing member is provided with a first coupling tube and a second coupling tube, one end of the first coupling tube being provided with a first heat conduction opening, one end of the second coupling tube being provided with a second heat conduction opening, the flow channel board being provided with a third heat conduction opening and a fourth heat conduction opening.

One or multiple of the above-described technical solutions of a multiple flow channel full contact fin heat exchange mechanism according to the embodiment of the present invention has at least one of the following technical effects:

By having multiple groups of heat exchange flow channels arranged between the heat transfer assembly and the heat concentration unit and two adjacent groups of heat exchange flow channels connected in sequence and arranged in parallel in a linear direction, during a course of heat exchange, fluid flows in the heat exchange flow channels and is directly in direct contact with the heat transfer assembly to fulfill heat exchange of the heat exchange mechanism, avoiding the situation where contact with fluid is prevented due to the presence of gaps, and increasing the heat exchange performance.

### BRIEF DESCRIPTION OF THE DRAWINGS

FIG. 1 is a schematic view showing an entire structure of a multiple flow channel full contact fin heat exchange mechanism according to an embodiment of the present invention.

FIG. 2 is a schematic view showing a structure of heat exchange fins of a heat transfer assembly of the multiple flow channel full contact fin heat exchange mechanism according to an embodiment of the present invention.

FIG. 3 is a schematic view showing an interior structure of the heat transfer assembly of the multiple flow channel full contact fin heat exchange mechanism according to an embodiment of the present invention.

FIG. 4 is a schematic view showing another interior structure of the heat transfer assembly of the multiple flow channel full contact fin heat exchange mechanism according to an embodiment of the present invention.

FIG. 5 is a schematic structure diagram showing a structure of a heat concentration board of the multiple flow channel full contact fin heat exchange mechanism according to an embodiment of the present invention.

FIG. 6 is a schematic structure diagram showing a structure of a sealing member of the multiple flow channel full contact fin heat exchange mechanism according to an embodiment of the present invention.

FIG. 7 is a schematic structure diagram showing a structure of a flow channel board of the multiple flow channel full contact fin heat exchange mechanism according to an embodiment of the present invention.

FIG. 8 is a schematic view showing another entire structure of the multiple flow channel full contact fin heat exchange mechanism according to an embodiment of the present invention.

### DETAILED DESCRIPTION OF THE PREFERRED EMBODIMENTS

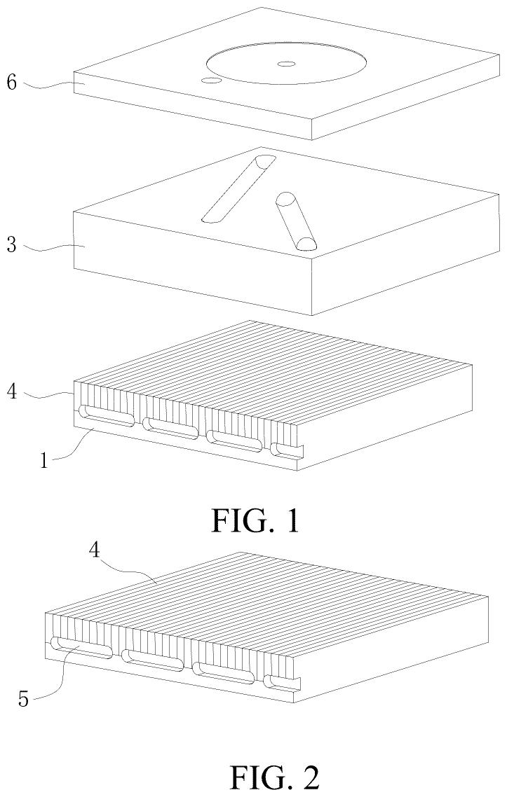

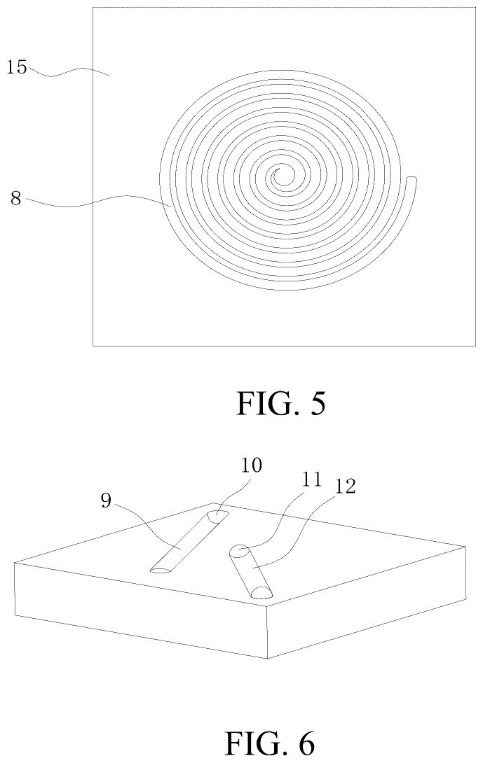

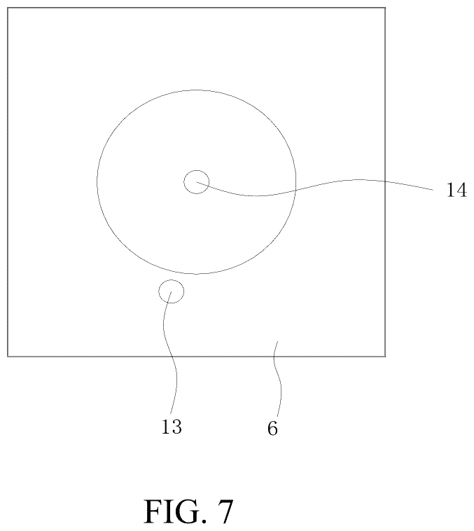

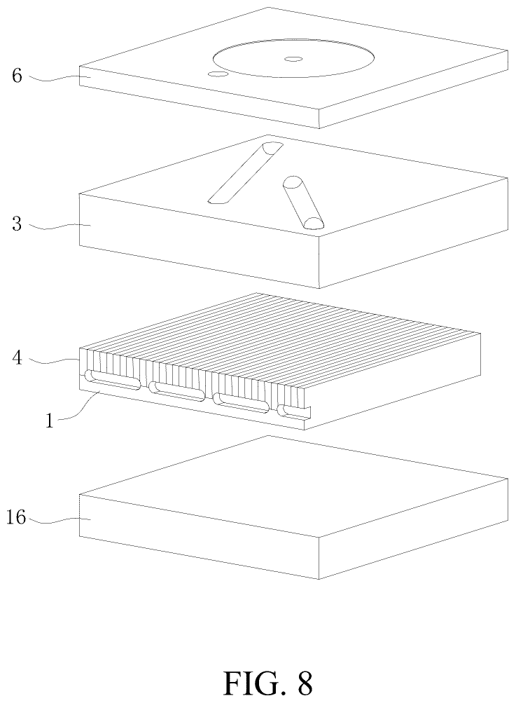

The following provides a detailed description of an embodiment of the present invention, and an illustrative example of the embodiment is shown in the drawings, in which, from being to end, the same or similar reference signs indicate the same or similar elements or elements having the same or similar functions. The embodiment described below with reference to FIGS. 1-8 is illustrative only, aiming to explain the embodiment of the present invention, and should not be construed as limiting to the present invention.

In the description of the embodiment of the present invention, it is understood that the terms “length”, “width”, “up”, “down”, “front”, “rear”, “left”, “right”, “vertical”, “horizontal”, “top”, “bottom”, “inside”, and “outside” indicating directional or positional relationship are interpreted according to the directional or positional relationship depicted in the drawings and are only adopted for easy illustration of the embodiment of the present invention and simplification of the description, and do not indicate or imply a device or element referred to thereby must have a specific direction or must be constructed and operated in a specific direction, and thus, should not be construed as limiting to the present invention.

Further, the terms “first” and “second” are used only for description purposes and are not construed as indicating or implying relative importance or implicitly suggest the number of a technical feature referred to thereby. Thus, a feature defined with “first” and “second” can explicitly or implicitly includes one or more such feature, unless otherwise specifically stated.

In the embodiment of the present invention, unless otherwise explicitly defined and set, the terms “mounting”, “interconnecting”, “connecting”, and “fixing” should be interpreted in a broad sense, such as being fixedly connected or being detachably connected, or being integrated together; or being mechanically connected or electrically connected; or being directly connected or being indirectly connected through an intermediate medium, or interiors of two elements being in communication with each other or two elements being of a relationship of acting on each other. For those having ordinary knowledge of the technical field, the specific meaning of such terms as used in the embodiment of the present invention can be appreciated according to practical conditions.

In one embodiment of the present invention, as shown in FIGS. 1-8, a multiple flow channel full contact fin heat exchange mechanism is provided. In the instant embodiment, the multiple flow channel full contact fin heat exchange mechanism is applicable to a solar energy reflection light-concentration device and comprises a heat concentration unit 1 and a heat transfer assembly. The heat concentration unit 1 is arranged at a focusing position of the solar energy reflection light-concentration device, and the heat transfer assembly is arranged on the heat concentration unit 1, wherein multiple groups of heat exchange flow channels 7 are formed between the heat transfer assembly and the heat concentration unit 1, and two adjacent groups of heat exchange flow channels 7 are connected in sequence, and all of the heat exchange flow channels 7 are arranged as being parallel arranged in a linear direction.

Specifically, by having multiple groups of heat exchange flow channels 7 arranged between the heat transfer assembly and the heat concentration unit 1 and two adjacent groups of heat exchange flow channels 7 connected in sequence and arranged in parallel in a linear direction, during a course of heat exchange, fluid flows in the heat exchange flow channels 7 and is directly in direct contact with the heat transfer assembly to fulfill heat exchange of the heat exchange mechanism, avoiding the situation where contact with fluid is prevented due to the presence of gaps, and increasing the heat exchange performance.

Further, the heat transfer assembly comprises heat exchange fins 4, a sealing member 3, and a flow channel board 6. The number of the heat exchange fins 4 is multiple sets, and all of the heat exchange fins 4 are uniformly distributed on the heat concentration unit 1. The sealing member 3 is arranged on the heat concentration unit 1 and encloses all of the heat exchange fins 4. The flow channel board 6 is arranged on the sealing member 3. All of the heat exchange fins 4 are arranged side by side in a linear direction at intervals. In the instant embodiment, each group of heat exchange flow channels 7 is formed between two corresponding sets of heat exchange fins 4, and since the heat exchange flow channels 7 are formed between two corresponding sets of heat exchange fins 4, during heat exchange, fluid flows into the heat exchange flow channels 7 to directly contact the heat exchange fins 4. In remaining embodiments, the heat exchange flow channels 7 can be formed of an arrangement of gaps among multiple sets of heat exchange fins 4, meaning flowing directions of fluid in the gaps of adjacent ones of the multiple groups of heat exchange flow channels 7 are consistent, and as such, the flowing efficiency of the fluid is increased, avoiding the width of the heat exchange flow channels 7 being excessively small and flowing speed being excessively slow, to thereby avoid situation where certain areas of the heat transfer assembly are inaccessible to the fluid. In the instant embodiment, the heat exchange fins 4 is formed, as one piece, on the heat concentration unit 1 through stamping and cutting of a copper material. The thickness of a single set of heat exchange fins 4 is small, and the fluid, during a course of flowing in the heat exchange flow channels 7, can simultaneously contact the two ends of the heat exchange fins 4 to fulfill heat exchange, thereby realizing heat exchange and enhancing its own heat exchange efficiency.

Further, two adjacent groups of heat exchange flow channels 7 are connected and in communication with each other through a set of curved flow channels. Connecting and communicating made through the curved flow channels allows the fluid to directly contact the heat exchange fins 4, making the heat exchange performance better. Specifically, in the instant embodiment, the curved flow channels are arranged at the same side of the two adjacent groups of heat exchange flow channels 7 and are connected to and in communication with the two groups of heat exchange flow channels 7, and in remaining embodiments, the curved flow channels are arranged at the same side of multiple groups of heat exchange flow channels 7 and are connected and in communication with all corresponding heat exchange flow channels 7.

Further, to enhance the heat exchange performance of fluid in all of the heat exchange flow channels 7, the curved flow channels that are located two sides of a same batch of heat exchange flow channels 7 are distributed in a center symmetry manner about a center position of all heat exchange flow channels 7 corresponding thereto, and the entirety of two sets of curved flow channels and the corresponding heat exchange flow channels 7 is of an arrangement of Z-shaped configuration in a cross section thereof, when viewed from top side, so that flowing directions of fluid in two adjacent batches of heat exchange flow channels 7 are opposite, so as to enhance the heat exchange performance.

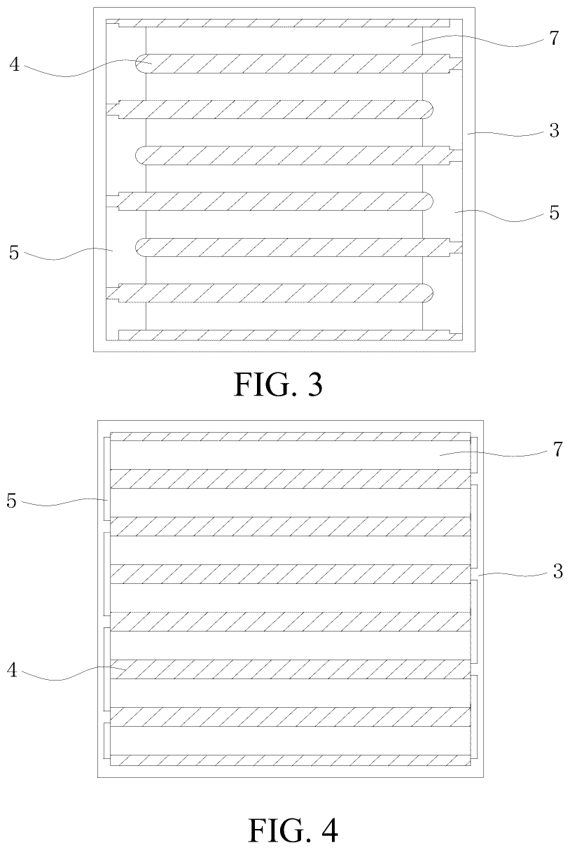

Further, one way of forming the curved flow channels is as follows. In the instant embodiment, flow guide holes 5 are provided as the curved flow channels, and as shown in FIG. 3, the heat exchange fins 4 are formed with multiple sets of flow guide holes 5 in two ends thereof in a linear direction, and the flow guide holes 5 are connected and in communication with the heat exchange flow channels 7, and the flow guide holes 5 and the heat exchange flow channels 7 are perpendicular to each other. In two sets of flow guide holes 5 that are connected to a same batch of heat exchange flow channels 7, output ends of one set of flow guide holes 5 are connected to corresponding heat exchange flow channels 7, and input ends of another set of flow guide holes 5 are connected to corresponding heat exchange flow channels 7. By arranging multiple sets of flow guide holes 5 at two ends of the heat exchange fins 4, fluid flows through the input ends of one set of flow guide holes 5 into the heat exchange flow channels 7, and changes the direction by means of the flow guide holes 5 to have the fluid directions in two adjacent batches of heat exchange flow channels 7 opposite to each other, to flow out of the output ends of another set of flow guide holes 5, making fluid orderly flow in all heat exchange flow channels 7 to enhance the flowability of fluid and thus enhance the heat exchange performance.

Since the thickness of the heat exchange fins 4 is small and the property of plasticity is high, directly machining the heat exchange fins 4 to form the flow guide holes 5 is more advantageous in reducing the difficulty of machining of the flow guide holes 5 and improving the manufacturing efficiency of the heat exchange mechanism.

Further, another way of forming the curved flow channel is as follows. In the instant embodiment, flow guide holes 5 are provide as the curved flow channel, and as shown in FIG. 4, two ends of the inside of the sealing member 3 in a linear direction are both formed with multiple sets of flow guide holes 5 penetrating therethrough, and the flow guide holes 5 are connected and in communication with the heat exchange flow channels 7, and the flow guide holes 5 and the heat exchange flow channels 7 are perpendicular to each other. In two sets of flow guide holes 5 that are connected to a same batch of heat exchange flow channels 7, output ends of one set of flow guide holes 5 are connected to corresponding heat exchange flow channels 7, and input ends of another set of flow guide holes 5 are connected to corresponding heat exchange flow channels 7. By arranging multiple sets of flow guide holes 5 at two ends of the sealing member 3, the multiple groups of heat exchange flow channels 7 form flow channels that are connected and in communication with one another, making fluid orderly flow in all heat exchange flow channels 7 to enhance the flowability of fluid and thus enhance the heat exchange performance.

Since the thickness of the heat exchange fins 4 is small, insufficiency of machining precision or excessively high site temperature occurring in a machining process may result in occurrence of deformation of a main body of the heat exchange fins 4, making two adjacent sets of heat exchange fins 4 approaching each other to cause blockade of the heat exchange flow channels 7. Thus, machining the sealing member 3 to form the flow guide holes 5 therein is more advantageous in improving structure stability of the heat exchange flow channels 7 and improving the manufacturing efficiency of the heat exchange mechanism.

Further, the sealing member 3 is of a frame configuration, and the sealing member 3 is arranged on an outside of the heat concentration unit 1, and the sealing member 3 is set in tight contact engagement with the heat concentration unit 1.

Further, the sealing member 3 is formed a water inlet hole 13 and a water outlet hole 14, and fluid flows from the water inlet hole 13 to pass in sequence through all heat exchange flow channels 7, and then flow out of the water outlet hole 14.

Further, the heat concentration unit 1 comprises a heat concentration board 15 and heat-increasing helical rings 8. The heat concentration board 15 is arranged on the heat concentration unit 1. Multiple sets of heat-increasing helical rings 8 are arranged at the center of the heat concentration board 15. The heat-increasing helical rings 8 are provided with areas for increasing heat absorption. The heat-increasing helical rings 8 are of a helical structure. A source of heat supply to the heat concentration unit 1 can be a reflection hood of the solar energy reflection light-concentration device or a CPU processor 16. The way that the heat concentration unit receives heat is flexible and all that satisfy heat radiation or heat conduction principle belong to the heat concentration unit.

Further, the sealing member 3 is provided with a first coupling tube 9 and a second coupling tube 12. One end of the first connection tube 9 is provided with a first heat conduction opening 10, and one end of the second coupling tube 12 is provided with a second heat conduction opening 11. The flow channel board 6 is formed with a third heat conduction opening 13 and a fourth heat conduction opening 14.

Further, by having multiple groups of heat exchange flow channels 7 arranged between the heat transfer assembly and the heat concentration unit 1 and two adjacent groups of heat exchange flow channels 7 connected in sequence and arranged in parallel in a linear direction, during a course of heat exchange, fluid flows in the heat exchange flow channels 7 and is directly in direct contact with the heat transfer assembly to fulfill heat exchange of the heat exchange mechanism, avoiding the situation where contact with fluid is prevented due to the presence of gaps, and increasing the heat exchange performance.

I claim:

1. A multiple flow channel full contact fin heat exchange mechanism, which is applicable to a solar energy reflection light-concentration device, comprising:
a heat concentration unit, which is arranged at a focusing position of the solar energy reflection light-concentration device; and
a heat transfer assembly, which is arranged on the heat concentration unit;
wherein multiple groups of heat exchange flow channels are formed between the heat transfer assembly and the heat concentration unit, and two adjacent groups of heat exchange flow channels are connected in sequence, and all of the heat exchange flow channels are arranged as being parallel arranged in a linear direction.

2. The multiple flow channel full contact fin heat exchange mechanism according to claim 1, wherein the heat transfer assembly comprises:
heat exchange fins, multiple sets of the heat exchange fins being uniformly distributed on the heat concentration unit;
a sealing member, which is arranged on the heat concentration unit and encloses all of the heat exchange fins; and
a flow channel board, which is arranged on the sealing member;
wherein all of the heat exchange fins are arranged side by side in a linear direction at intervals, and each group of heat exchange flow channels is formed between two sets of the heat exchange fins that correspond to each other.

3. The multiple flow channel full contact fin heat exchange mechanism according to claim 2, wherein two adjacent groups of heat exchange flow channels are connected and in communication with each other by means of one single set of curved flow channels.

4. The multiple flow channel full contact fin heat exchange mechanism according to claim 3, wherein the heat exchange fins are formed, in a penetrating manner in both two ends thereof in a linear direction, with multiple sets of flow guide holes, and the flow guide holes are connected and in communication with the heat exchange flow channels, and the flow guide holes and the heat exchange flow channels are perpendicular to each other.

5. The multiple flow channel full contact fin heat exchange mechanism according to claim 3, wherein the sealing member is formed, in a penetrating manner in both two ends of inside thereof in a linear direction, with multiple sets of flow guide holes, and the flow guide holes are connected and in communication with the heat exchange flow channels, and the flow guide holes and the heat exchange flow channels are perpendicular to each other.

6. The multiple flow channel full contact fin heat exchange mechanism according to claim 3, wherein the heat exchange flow channels are formed, in a penetrating manner in both two ends thereof in a linear direction, with multiple sets of flow guide holes, and each set of flow guide holes accommodates at least two groups of heat exchange flow channels, and each set of flow guide holes is arranged, in a staggered manner, at two ends of the heat exchange flow channels in a linear direction.

7. The multiple flow channel full contact fin heat exchange mechanism according to claim 2, wherein the sealing member is of a frame configuration arranged at an outside of the heat concentration unit, and the sealing member is in tight contact engagement with the heat concentration unit.

8. The multiple flow channel full contact fin heat exchange mechanism according to claim 7, wherein the sealing member is formed, in a penetrating manner, with a water inlet hole and the water outlet hole, and fluid flows from the water inlet hole to sequentially pass through multiple groups of the heat exchange flow channels, to then flow out of the water outlet hole.

9. The multiple flow channel full contact fin heat exchange mechanism according to claim 7, wherein the heat concentration unit comprises:
a heat concentration board, which is arranged on the heat concentration unit;
heat-increasing helical rings, multiple sets of heat-increasing helical ring being at a center of the heat concentration board, the heat-increasing helical rings being provided for expanding a light absorption area, the heat-increasing helical rings being of a helical structure.

10. The multiple flow channel full contact fin heat exchange mechanism according to claim 2, wherein a first coupling tube and a second coupling tube are formed between the sealing member and the flow channel board, one end of the first coupling tube being provided with a first heat conduction opening, one end of the second coupling tube being provided with a second heat conduction opening, the flow channel board being provided with a third heat conduction opening and a fourth heat conduction opening.
